(19) United States
(12) Patent Application Publication
(10) Pub. No.: US 2025/0095605 A1
(43) Pub. Date: Mar. 20, 2025

(54) Shared Components in Pulsed Electronic Displays

(71) Applicant: Apple Inc., Cupertino, CA (US)

(72) Inventors: Baris Posat, Saratoga, CA (US); John T. Wetherell, San Jose, CA (US); Hasan Akyol, Los Altos, CA (US); Mahdi Farrokh Baroughi, Santa Clara, CA (US); Hopil Bae, Palo Alto, CA (US)

(21) Appl. No.: 18/625,158

(22) Filed: Apr. 2, 2024

Related U.S. Application Data
(60) Provisional application No. 63/583,806, filed on Sep. 19, 2023.

(51) Int. Cl. G09G 5/00

(52) U.S. Cl. CPC G09G 5/003; G09G 2300/06; G09G 2310/0289

(57) ABSTRACT

Electronic displays may display a frame of image content by controlling emissions of display pixels. To this end, the electronic display may include one or more column drivers that drive the display pixels to emit light. The column drivers may be collectively compensated by common components, such as a single sampling capacitor and/or an analog buffer, which may reduce a size of the column drivers. In another example, the column drivers may include cascode transistors with increased width-to-length ratio and share a common n-well. Each transistor may be compensated by a respective capacitor, however a size of each sampling capacitor may be reduced, thereby reducing a size of the column driver. Moreover, a size of a level shifter may be reduced by operating transistors of the level shifter with sub-threshold voltage. Furthermore, a resolution of the electronic display may be improved by extending a pulse of an emission clock signal.

### CROSS-REFERENCE TO RELATED APPLICATIONS

This application claims priority to U.S. Provisional Application No. 63/583,806, filed Sep. 19, 2023, which is incorporated by reference herein in its entirety for all purposes.

### SUMMARY

The present disclosure relates generally to electronic displays, and, more particularly, pulsed electronic displays having micro-drivers that are reduced in size.

A summary of certain embodiments disclosed herein is set forth below. It should be understood that these aspects are presented to provide the reader with a brief summary of these certain embodiments and that these aspects are not intended to limit the scope of this disclosure.

Electronic displays may be found in numerous electronic devices, from mobile phones to computers, televisions, automobile dashboards, and augmented reality or virtual reality glasses, to name just a few. Electronic displays with self-emissive display pixels produce their own light. Self-emissive display pixels may include any suitable light-emissive elements, including light-emitting diodes (LEDs) such as organic light-emitting diodes (OLEDs) or micro-light-emitting diodes (micro-LEDs). By causing different display pixels to emit different amounts of light, individual display pixels of an electronic display may collectively produce images.

Pulsed electronic displays use local passive matrices (LPMs) of display pixels that are pulsed when driven by micro-driver circuitry specific to each LPM. By adjusting the amount of time each display pixel is pulsed, different display pixels may emit different amounts of light, allowing the display pixels on the electronic display to collectively present a frame of image content (e.g., an image). Each micro-driver may be able to drive one row of display pixels at one time. As such, illuminating all of the display pixels may involve driving each row of display pixels separately according to a time division multiplexing scheme over a period of time. The viewer's eyes may integrate the light emitted by all of the display pixels of the rows over the period of time to perceive a cohesive image.

As electronic displays increase in size, simply increasing the number of rows in each LPM may result in perceivable image artifacts or inefficient operation of the electronic display. For example, if time division multiplexing occurs over a longer period of time to account for the additional rows of the larger electronic display, it may be possible that the user perceives flickering artifacts. However, operating the multiplexers at an increased frequency to maintain the period of time division multiplexing may reduce the efficiency of the micro-driver due to dynamic power losses. Accordingly, some micro-drivers may include multiple current sources in which two or more current sources simultaneously drive a respective pixel of different rows of one LPM. To do so, a first emission line coupled to a first current source may be coupled to a first set of pixels of a first set of rows, and a second emission line coupled to a second current source may be coupled to a second set of pixels of a second set of rows. The second emission line may cross over or under at least one row of the first set of rows to reach the second set of pixels of the second set of rows. Thus, the first current source and the second current source may simultaneously drive different respective pixels from the different sets of rows. This allows the size of the LPM to increase even if the frequency is substantially maintained.

Each column driver may have slightly different behavior. For example, different medium voltage (MV) driving transistors may have slightly different threshold voltages (Vth) that correspond to providing a current to drive the display pixels. The different behaviors may be compensated using a respective sampling capacitor to account for differences in threshold voltage (Vth). With the increasing electronic display size, the micro-driver circuitry may take up a substantial amount of space on the integrated circuit due to the MV transistors and the respective sampling capacitors. Accordingly, a size of the column driver may be reduced by collectively compensating the column drivers and/or the display pixels. For example, two or more column drivers may be collectively compensated using a single sampling capacitator that holds an average threshold voltage of transistors used in the column drivers. In addition, the sampling capacitor may be coupled to an analog buffer that provides an output to the transistors of the column drivers. As such, the column drivers may be collectively compensated by common components, such as the sampling capacitor and the analog buffer, which may reduce a size of the column drivers.

Another large component used in the micro-driver may be a level shifter that translates digital signals corresponding to image data into various different voltage levels appropriate for driving the display pixels of the electronic display. Although some level shifters may use eight or more transistors to translate the digital signals and, thus, the transistors may occupy a substantial amount of space on the integrated circuit. In this disclosure, the level shifter may include four transistors used to convert a digital signal into various different voltage levels. For example, the transistors may operate at a sub-threshold voltage to reduce a number of transistors used to switch voltage levels on or off.

As discussed herein, the display pixels may be driven by the micro-driver to emit light and form a frame of image content. The micro-driver may drive the display pixels based on signals from an emission clock. For example, a total pulse width of each emission pulse of the display pixels may be the sum of some specific number of emission clock pulses that increase in pulse width monotonically to correspond with the way the human eye detects relative changes in luminance (e.g., brightness). For example, a digital code of four may correspond to four emission block pulses, in which a second pulse of the emission block may be slightly longer than the first pulse, the third slightly longer than the second, and so forth. The resolution of the brightness of the display pixels be limited by the resolution of the emission block. In this disclosure, the resolution of the emission clock may be extended by adding a programmable delay to the emission clock signal. For example, a programmable delay may be provided by one or more delay cells and added to the emission clock signal to generate an extended emission clock signal. By way of example, the extended emission clock signal may be extended by a fractional amount in comparison to the emission clock signal. The extended emission clock signal may drive the display pixels on for a respective period of time, which may improve the resolution of the display panel.

### BRIEF DESCRIPTION OF THE DRAWINGS

Various aspects of this disclosure may be better understood upon reading the following detailed description and upon reference to the drawings in which:

FIG. 1 is a block diagram of an electronic device that includes an electronic display, in accordance with an embodiment;

FIG. 2 is an example of the electronic device of FIG. 1 in the form of a handheld device, in accordance with an embodiment;

FIG. 3 is another example of the electronic device of FIG. 1 in the form of a tablet device, in accordance with an embodiment;

FIG. 4 is another example of the electronic device of FIG. 1 in the form of a computer, in accordance with an embodiment;

FIG. 5 is another example of the electronic device of FIG. 1 in the form of a watch, in accordance with an embodiment;

FIG. 6 is another example of the electronic device of FIG. 1 in the form of a computer, in accordance with an embodiment;

FIG. 7 is a schematic diagram of a micro-LED display that employs micro-drivers to drive display pixels with controls signals, in accordance with an embodiment;

FIG. 8 is a block diagram of circuitry that may be part of a micro-driver of FIG. 7, in accordance with an embodiment;

FIG. 9 is a timing diagram of an example operation of the circuitry of FIG. 8, in accordance with an embodiment;

FIG. 10 is a schematic illustration of the micro-LED display of FIG. 7, where a micro-driver controls a collection of anodes and display pixels based on a digital code, in accordance with an embodiment of the present disclosure;

FIG. 11 is a circuit diagram of the micro-driver of FIG. 7 coupled to a local passive matrix (LPM), in accordance with an embodiment;

FIG. 12 is a flowchart of an example method or process for operating LPM using the micro-driver of FIG. 11, in accordance with an embodiment;

FIG. 13 is a circuit diagram of the micro-driver of FIG. 7 with a common component to compensate the column drivers, in accordance with an embodiment;

FIG. 14 is a circuit diagram of the micro-driver of FIG. 7 with common components to compensate the column drivers, in accordance with an embodiment;

FIG. 15 is a circuit diagram of a level shifter used in the micro-driver of FIG. 7, in accordance with an embodiment;

FIG. 16 is a timing diagram for operating the level shifter of FIG. 15 to convert a signal from a one-volt domain to an analog voltage domain, in accordance with an embodiment;

FIG. 17 is a circuit diagram of the level shifter coupled to column drivers of the micro-driver of FIG. 7, in accordance with an embodiment;

FIG. 18 is a circuit diagram of an emission (EM) pulse generator that adds a programmable delay to an emission clock signal to generate an extended emission clock signal, in accordance with an embodiment;

FIG. 19 is a timing diagram for operating the EM pulse generator of FIG. 18 to add the programmable delay, in accordance with an embodiment; and

FIG. 20 is a flowchart of an example method or process for operating the EM pulse generator of FIG. 18 to add the programmable delay, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Pulsed electronic displays use local passive matrices (LPMs) of display pixels that are pulsed when driven by micro-driver circuitry specific to each LPM. By adjusting the amount of time each display pixel is pulsed, different display pixels may emit different amounts of light, allowing the display pixels on the electronic display to collectively represent an image. As electronic displays increase in size, simply increasing the number of rows in each LPM may result in perceivable image artifacts viewed by a viewer and/or inefficient operation of the electronic device. Additionally or alternatively, the micro-drivers may increase in size to accommodate the increased LPMs, which may result in significant layout space within the electronic display being occupied by the micro-drivers. Lastly, the electronic display may be limited to a resolution of an emission clock. That is, the amount of time each display pixel is pulsed may correspond to an emission clock signal. The emission pulses may be limited by resolution of the emission clock, which may also limit a range of brightness levels provided by the display pixels when displaying a frame of image content.

In an instance, the local passive matrices (LPM) of the electronic displays may be made larger by grouping rows of the LPM into portions that may be simultaneously driven using one micro-driver to drive multiple rows at one time. In this way, one micro-driver may drive multiple rows at once without operating at a higher frequency that may produce higher dynamic power losses. For example, the LPM may include a total of 32 rows divided into two portions that each include 16 rows. One selected row of the first portion may be driven at the same time as one selected row of the second portion by coupling the selected two rows to a common negative voltage source (VNEG) and increasing a number of column drivers used in the micro-driver. In another example, the LPM may include a total of 32 rows divided into four portions each having 8 rows. One selected row of the first portion, one selected row of the second portion, one selected row of the third portion, and one selected row of the fourth portion may be driven simultaneously by coupling the four selected rows to the common negative voltage source and increasing the number of column drivers. As such, a size of the electronic device may be increase, image content displayed to the viewer may be viewed without perceivable image artifacts, and/or power losses may be reduced.

Additionally or alternatively, a size of the micro-driver circuitry may be reduced by reducing a size of the column drivers. For example, two or more column drivers may be collectively compensated using a single sampling capacitor instead of being individually compensated using different respective sampling capacitators. The two or more column drivers may share an analog buffer and a single, larger common sampling capacitor that may compensate the analog buffer. The output of the analog buffer may be provided to low-voltage (LV) transistors that share a common n-well. The LV transistors may provide a better threshold voltage (Vth) matching in comparison to the MV transistors that may be conventionally used in the micro-driver. For example, the LV transistor may operate as a current source that may be combined with an MV cascade transistor to improve current generation without individual compensation.

In another example, micro-driver circuitry may include capcode transistors with an increased width-to-length (W/L) ratio and also share a common n-well. As a result of using two transistors per column driver, the micro-driver may also include two sampling capacitors per column driver that individually compensate the cascaded transistor. To reduce a size of the micro-driver circuitry, a size of the sampling capacitors may be reduced by at least half. Additionally or alternatively, placing the cascode transistors in a common n-well may reduce space occupied on the integrated circuit since spacing between n-wells may be reduced or eliminated.

Another large component used in the micro-driver may be the level shifter which provides voltage level shifting. The level shifter may use a reduce number of transistors, thereby taking up less space on the integrated circuit. The level shifter, for example, may use four transistors rather than the eight transistors conventionally be used. To this end, one or more transistors of the level shifter may operate at a sub-threshold conduction (e.g., voltage). In other words, the transistors may be pre-charged to a voltage level. As such, the transistors may be held weakly on during operation. By using some transistors that may be held weakly on, fewer transistors may be used to switch voltage levels between on and off.

The resolution of the electronic display may be adjusted by adding a delay to an emission clock signal. For example, an emission timing controller may provide an emission clock signal used to drive the display pixel. The resolution of the emission clock signal may limit a resolution of the electronic display since a pulse of the display pixels may align with the emission clock signal. In certain instances, the resolution of the emission clock may be extended by adding a programmable delay to pulses of the emission clock. This allows the pulse (e.g., pulse width) of the display pixels to be extended by a fractional amount, thereby increasing the resolution of the electronic display. For example, the extension may be applied to both rising and/or falling edges of the emission (EM) pulses.

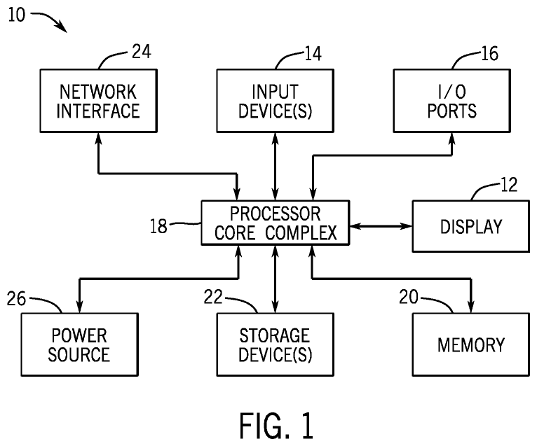

With the preceding in mind and to help illustrate, an electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuitry(s) or processing circuitry cores, local memory 20, a main memory storage device 22, a network interface 24, and a power source 26 (e.g., power supply). The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components or reutilize display components in the electronic display 12. The touch sensing components may receive user inputs by detecting occurrence or position of an object touching the surface of the electronic display 12.

In addition to enabling user inputs, the electronic display 12 may include a display panel with display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW arrangement).

The electronic display 12 may display an image by controlling light emission from its display pixels based on pixel or image data associated with corresponding image pixels (e.g., points) in the image. In some embodiments, pixel or image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on pixel or image data generated by the processor core complex 18, or the electronic display 12 may display frames based on pixel or image data received via the network interface 24, an input device, or an I/O port 16.

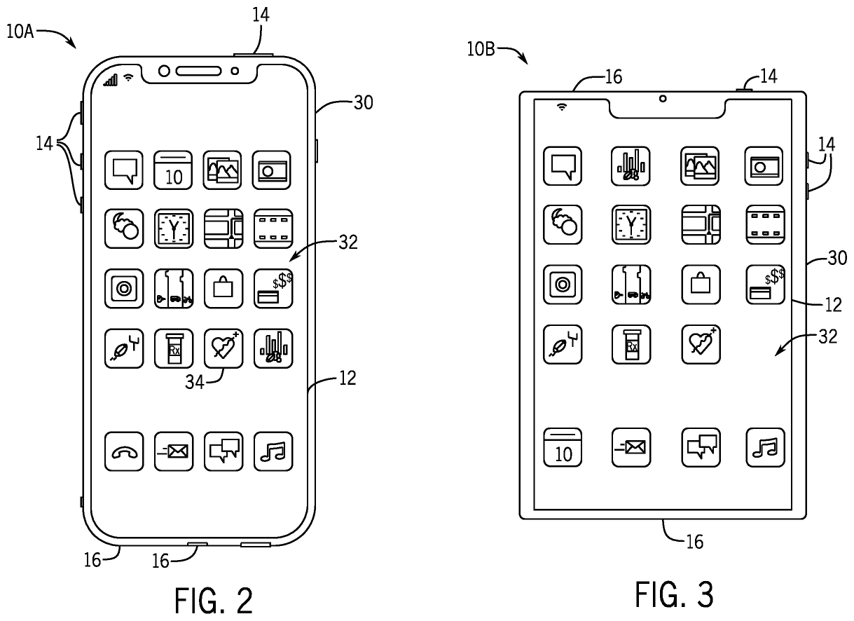

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as any iPhone® model available from Apple Inc.

The handheld device 10A includes an enclosure 30 (e.g., housing). The enclosure 30 may protect interior components from physical damage or shield them from electromagnetic interference, such as by surrounding the electronic display 12. The electronic display 12 may display a graphical user interface (GUI) 32 having an array of icons. When an icon 34 is selected either by an input device 14 or a touch-sensing component of the electronic display 12, an application program may launch.

The input devices 14 may be accessed through openings in the enclosure 30. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

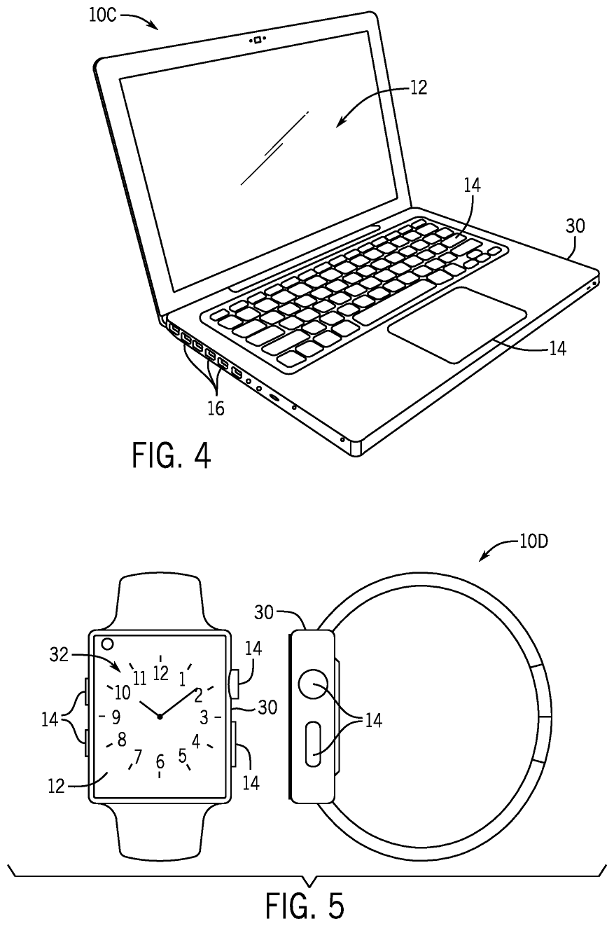

Another example of a suitable electronic device 10, specifically a tablet device 10B, is shown in FIG. 3. The tablet device 10B may be any iPad® model available from Apple Inc. A further example of a suitable electronic device 10, specifically a computer 10C, is shown in FIG. 4. For illustrative purposes, the computer 10C may be any MacBook® or iMac® model available from Apple Inc. Another example of a suitable electronic device 10, specifically a watch 10D, is shown in FIG. 5. For illustrative purposes, the watch 10D may be any Apple Watch® model available from Apple Inc. As depicted, the tablet device 10B, the computer 10C, and the watch 10D each also includes an electronic display 12, input devices 14, I/O ports 16, and an enclosure 30. The electronic display 12 may display a GUI 32. Here, the GUI 32 shows a visualization of a clock. When the visualization is selected either by the input device 14 or a touch-sensing component of the electronic display 12, an application program may launch, such as to transition the GUI 32 to presenting the icons 34 discussed in FIGS. 2 and 3.

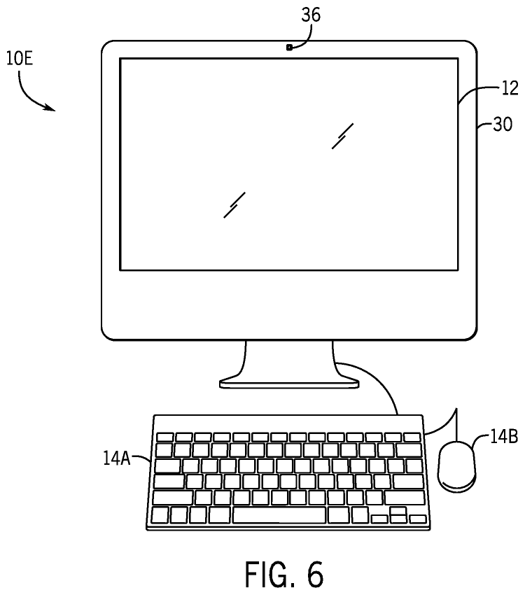

Turning to FIG. 6, a computer 10E may represent another embodiment of the electronic device 10 of FIG. 1. The computer 10E may be any computer, such as a desktop computer, a server, or a notebook computer, but may also be a standalone media player or video gaming machine. By way of example, the computer 10E may be an iMac®, a MacBook®, or other similar device by Apple Inc. of Cupertino, California. It should be noted that the computer 10E may also represent a personal computer (PC) by another manufacturer. A similar enclosure 36 may be provided to protect and enclose internal components of the computer 10E, such as the electronic display 12. In certain embodiments, a user of the computer 10E may interact with the computer 10E using various peripheral input structures 14, such as the keyboard 14A or mouse 14B (e.g., input structures 14), which may connect to the computer 10E.

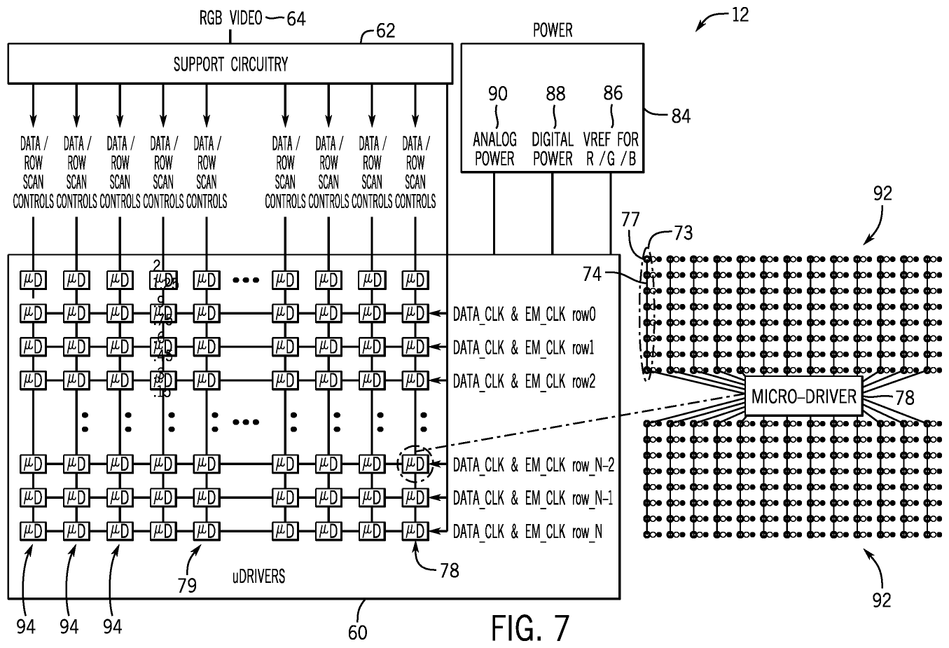

FIG. 7 depicts a block diagram of an example architecture of the electronic display 12 (e.g., micro-LED display). In the example of FIG. 7, the electronic display 12 uses an RGB display panel 60 with pixels that include red, green, and blue micro-LEDs as display pixels. Support circuitry 62 may receive RGB-format video image data 64. It should be appreciated, however, that the electronic display 12 may alternatively display other formats of image data, in which case the support circuitry 62 may receive image data of such different image format. In some embodiments, the support circuitry 62 may include a video timing controller (video TCON) and/or emission timing controller (emission TCON) that receives and uses the image data 64 in a serial bus to determine a data clock signal (DATA_CLK) and/or an emission clock signal (EM_CLK) to control the provision of the image data 64 in the electronic display 12. The video TCON may also pass the image data 64 to a serial-to-parallel circuitry that may descrialize the image data 64 signal into several parallel image data signals. That is, the serial-to-parallel circuitry may collect the image data 64 into the particular data signals that are passed on to specific columns among a total of M respective columns in the display panel 60. As noted above, the video TCON may generate the data clock signal (DATA_CLK), and the emission TCON may generate the emission clock signal (EM_CLK). Collectively, these may be referred to as Data/Row Scan Control signals, as illustrated in FIG. 7. As such, the data is labeled DATA/ROW SCAN CONTROLS. The data/row scan controls respectively contain image data corresponding to pixels in the first column, second column, third column, fourth column . . . fourth-to-last column, third-to-last column, second-to-last column, and last column, respectively. The data/row scan controls may be collected into more or fewer columns depending on the number of columns that make up the display panel 60.

In particular, the display panel 60 includes micro-drivers 78. The micro-drivers 78 are arranged in an array 79. Each micro-driver 78 drives a number of display pixels 77. The display pixels 77 driven by each micro-driver 78 may be arranged as a local passive matrix (LPM) 92. In one example, each micro-driver 78 drives two local passive matrices (LPMs) 92 of display pixels 77, one above the micro-driver 78 and one below the micro-driver 78. Before continuing, it should be appreciated that the array 79 may have LPM columns 94 that include multiple different LPMs 92 that are driven by different micro-drivers 78. For each LPM 92, different display pixels 77 may include different combination of colored micro-LEDs (e.g., a red micro-LED, a green micro-LED, or a blue micro-LED) to represent the image data 64 in RGB format. For example, the combinations may include a red micro-LED and a green micro-LED, a blue micro-LED and a green micro-LED, a red micro-LED and a blue micro-LED, and so on. Although one of the micro-drivers 78 of FIG. 7 is shown to drive a local passive matrix (LPM) 92 having twenty-six anode groups 73 having eight display pixels 77 each, each micro-driver 78 may drive more or fewer anode groups 73 and respective display pixels 77. As illustrated, the subset of display pixels 77 located on each anode group 73 may be associated with a particular color (e.g., red, green, blue). As mentioned above, it should be noted that a respective cathode corresponds to a subset of display pixels 77 associated with a particular color even though each cathode for a particular color channel is not illustrated in FIG. 7. For example, anode 74 corresponds to a red color channel (e.g., subset of red display pixels 77) and there may be a corresponding shared cathode for all color channels or a separate cathode corresponding to the red color channel. There are a second set of anodes that couple to a green color channel (e.g., subset of green display pixels 77) and a third set of anodes that couple to a blue color channel (subset of blue display pixels 77), but these are not expressly illustrated in FIG. 7 for case of description. Each micro-driver 78 may drive one row of display pixels 77 of each LPM at a time.

A power supply 84 may provide a reference voltage (VREF) 86 to drive the micro-LEDs, a digital power signal 88, and an analog power signal 90. In some cases, the power supply 84 may provide more than one reference voltage (VREF) 86 signal. Namely, display pixels 77 of different colors may be driven using different reference voltages. As such, the power supply 84 may provide more than one reference voltage (VREF) 86. Additionally or alternatively, other circuitry on the display panel 60 may step the reference voltage (VREF) 86 up or down to obtain different reference voltages to drive different colors of micro-LED.

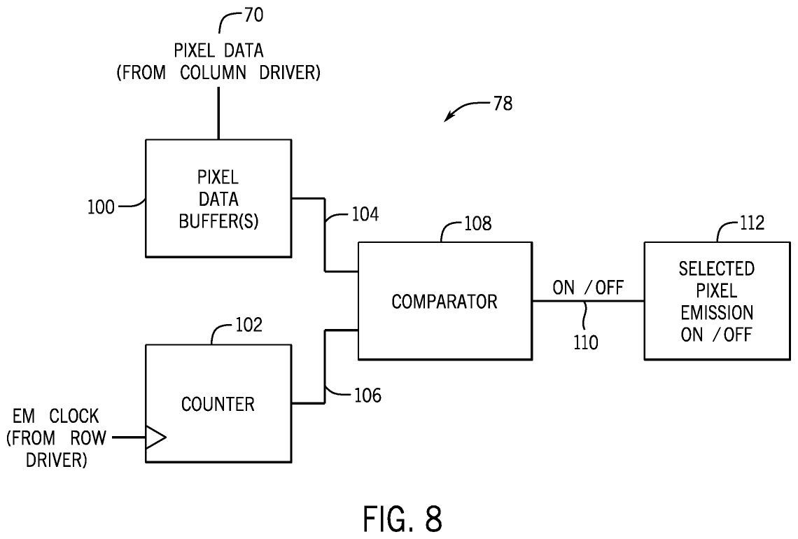

A block diagram shown in FIG. 8 illustrates some of the components of one of the micro-drivers 78 used to drive one display pixel 77. The micro-driver 78 shown in FIG. 7 includes pixel data buffer(s) 100 and a digital counter 102. The pixel data buffer(s) 100 may include sufficient storage to hold the image data 70 that is provided. For instance, the micro-driver 78 may include pixel data buffers to store image data 70 for a display pixel 77 at any one time (e.g., for one RGB pixel group of 8-bit image data 70, this may be 24 bits of storage). It should be appreciated, however, that the micro-driver 78 may include more or fewer buffers, depending on the data rate of the image data 70, the number of display pixels 77 to be driven by the image data 70, and the number of pixels 77 in a row of one of the local passive matrices (LPMs) 92 driven by the micro-driver 78. The pixel data buffer(s) 100 may take any suitable logical structure based on the order that the column driver provides the image data 70. For example, the pixel data buffer(s) 100 may include a first-in-first-out (FIFO) logical structure or a last-in-first-out (LIFO) structure.

When the pixel data buffer(s) 100 has received and stored the image data 70, a row-driver may provide the emission clock signal (EM_CLK). The row-driver may be integrated within the micro-driver 78 or be a separate component within the electronic device 10 and communicatively coupled to the pixel data buffer(s) 100. A counter 102 may receive the emission clock signal (EM_CLK) as an input. The pixel data buffer(s) 100 may output enough of the stored image data 70 to output a digital data signal 104 to represent a desired gray level for a particular display pixel 77 that is to be driven by the micro-driver 78. The counter 102 may also output a digital counter signal 106 indicative of the number of edges (only rising, only falling, or both rising and falling edges) of the emission clock signal (EM_CLK) 98. The signals 104 and 106 may enter a comparator 108 that outputs an emission control signal 110 in an “on” state when the digital counter signal 106 does not exceed the digital data signal 104, and an “off” state otherwise. The emission control signal 110 may be routed to driving circuitry (not shown) for the display pixel 77 being driven, which may cause light emission 112 from the selected display pixel 77 to be on or off. The longer the selected display pixel 77 is driven “on” by the emission control signal 110, the greater the amount of light that will be perceived by the human eye as originating from the display pixel 77.

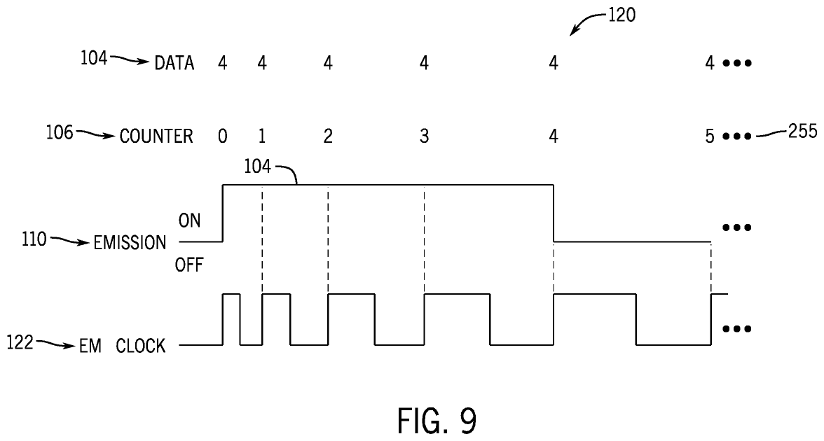

A timing diagram 120, shown in FIG. 9, provides one brief example of the operation of the micro-driver 78. The timing diagram 120 shows the digital data signal 104, the digital counter signal 106, the emission control signal 110, and the emission clock signal (EM_CLK) represented by numeral 122. In the example of FIG. 9, the gray level for driving the selected display pixel 77 is gray level 4, and this is reflected in the digital data signal 104. The emission control signal 110 drives the display pixel 77 “on” for a period of time defined as gray level 4 based on the emission clock signal (EM_CLK). Namely, as the emission clock signal (EM_CLK) rises and falls, the digital counter signal 106 gradually increases. The comparator 108 outputs the emission control signal 110 to an “on” state as long as the digital counter signal 106 remains less than the data signal 104. When the digital counter signal 106 reaches the value of the data signal 104, the comparator 108 outputs the emission control signal 110 to an “off” state, thereby causing the selected display pixel 77 no longer to emit light.

It should be noted that the steps between gray levels are reflected by the steps between emission clock signal (EM_CLK) edges. That is, based on the way humans perceive light, to notice the difference between lower gray levels, the difference between the amounts of light emitted between two lower gray levels may be relatively small. To notice the difference between higher gray levels, however, the difference between the amounts of light emitted between two higher gray levels may be comparatively much greater. The emission clock signal (EM_CLK) therefore may use relatively short time intervals between clock edges at first. To account for the increase in the difference between light emitted as gray levels increase, the differences between edges (e.g., periods) of the emission clock signal (EM_CLK) may gradually lengthen. The particular pattern of the emission clock signal (EM_CLK), as generated by the emission TCON, may have increasingly longer differences between edges (e.g., periods) so as to provide a gamma encoding of the gray level of the display pixel 77 being driven.

### Common Drive for Multiple Regions of Local Passive Matrix

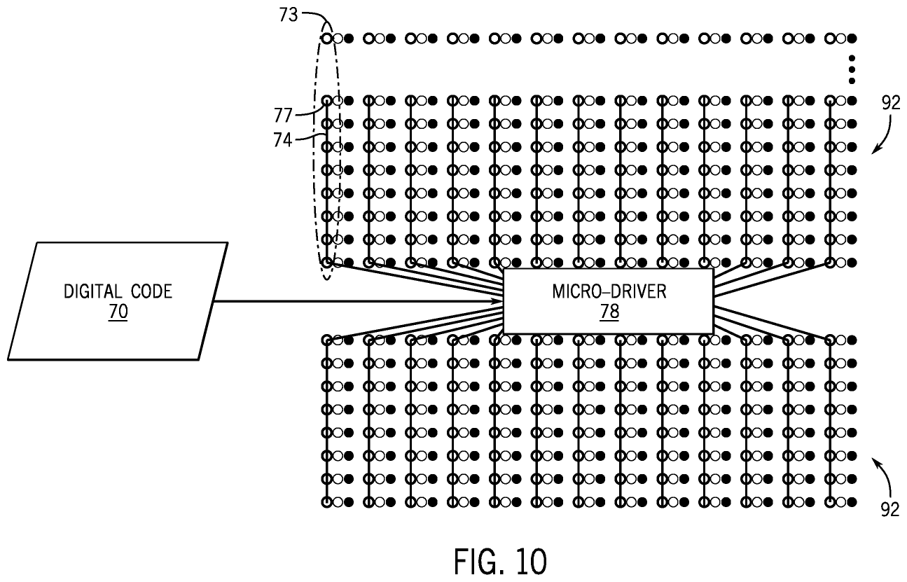

With the preceding in mind, FIG. 10 illustrates the micro-driver 78 driving the display pixels 77 according to the image data 70, and thereby enabling image content to be displayed by the electronic display 12. As mentioned above, the micro-driver 78 may drive any suitable number of display pixels 77, and a subset of display pixels 77 may be located on respective anodes 74 of the electronic display 12. As illustrated, the subset of display pixels 77 located on each anode 74 may be associated with a particular color (e.g., red, green, blue). The anode 74 may include any suitable number of display pixels 77, such as sixteen or more display pixels 77, thirty-two or more display pixels 77, sixty-four or more display pixels 77, and so on. As illustrated, the anodes 74 may include eight or more display pixels 77.

Further, it should be noted that a respective cathode corresponds to a subset of display pixels 77 associated with a particular color even though each cathode for a particular color channel is not illustrated in FIG. 10. For example, as illustrated, a first set of cathodes corresponds to a red color channel (e.g., subset of red display pixels 77). However, there may be a second set of cathodes that couple to a green color channel (e.g., subset of green display pixels 77) and a third set of cathodes that couple to a blue color channel (subset of blue display pixels 77). The second set of cathodes and the third set of cathodes are not expressly illustrated in FIG. 10 for case of description. As discussed with respect to FIG. 7, display pixels 77 driven by each micro-driver 78 may be arranged in the LPM 92. In the LPM 92, a respective cathode may be shared for all sub-pixel colors in a row of display pixels 77.

The electronic display 12 may include any suitable number of rows and columns and the micro-driver 78 may drive rows of the display pixels 77 to emit light to produce image content for display by the electronic display 12. For example, as discussed herein, the electronic display 12 may include sixteen or more rows of the display pixels 77, thirty-two or more rows of the display pixels 77, sixty-four or more rows of the display pixels 77, and so on. In certain instances, the micro-driver 78 may drive two or more rows of the display pixels 77 at one time. For example, the electronic display 12 may include thirty-two rows of the display pixels 77 divided into two regions each including sixteen rows of the display pixels 77. The micro-driver 78 may drive a row of display pixels 77 within a first region and a row of display pixels 77 within a second region at the same time. In another example, the electronic display 12 may include thirty-two rows of display pixels 77 divided into four regions. The micro-driver 78 may drive a row of the first region of the display pixels 77, a row of a second region of the display pixels 77, a row of a third region of the display pixels 77, and a row of a fourth region of the display pixels 77 at one time.

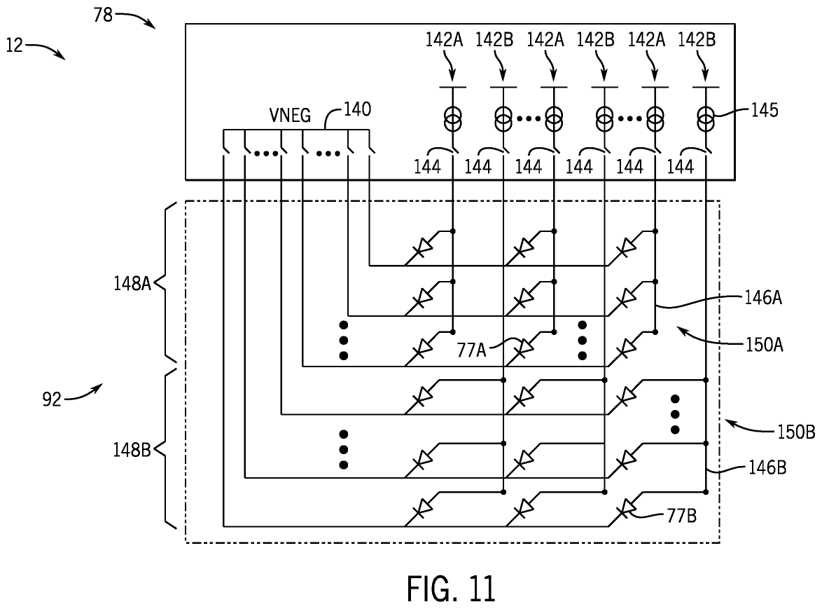

FIG. 11 is a circuit diagram of the micro-driver 78 coupled to the LPM 92. In particular, the FIG. 11 illustrates the micro-driver 78 coupled to one LPM 92. It may be understood that the micro-driver 78 may be coupled to a second LPM 92 positioned adjacent to the illustrated LPM 92, such as discussed with respect to FIGS. 7 and 10. The micro-driver 78 may drive rows of display pixels 77 within the LPM 92 to emit light.

To this end, the micro-driver 78 may include a power source 140 that provides a voltage and a negative voltage (VNEG) to drive the display pixels 77 (e.g., corresponding micro-LEDs). The power source 140 may be coupled to each column driver 142 to provide the voltage and each row of the LPM 92 and provide the negative voltage (VNEG). As such, a voltage difference may be created to drive the display pixels 77. The micro-driver 78 may also include column drivers 142 that provide a current source to drive the display pixels 77 (e.g., corresponding micro-LEDs). Each column driver 142 may include a switch 144 coupled to a current source 145. The column driver 142 may couple to one or more display pixels 77 via an emission line 146 (e.g., cathode). For example, the switch 144 may open to stop current flow along the emission line 146 to the display pixels 77 which may stop the display pixel 77 from emitting light. The switch 144 may close to provide current along the emission line 146 to the display pixel 77 for an amount of time. To create a frame of image content, for example, the switch 144 may receive the emission control signal 110 and close for a period of time indicated by the emission control signal 110 to provide current flow along the emission line 146.

As discussed herein, a size of the LPM 92 may be increased by the LPM 92 into two or more portions 148 that may be simultaneously driven by the micro-driver 78. As illustrated, the LPM 92 may divided into a first portion 148A positioned adjacent to the micro-driver 78 and a second portion 148B positioned adjacent to the first portion 148A. The first portion 148A may include a first set of rows 150A of display pixels 77 coupled to a first set of column drivers 142A that may drive a current through the display pixels 77 in the first set of rows 150A. The second portion 148B may include a second set of rows 150B of display pixels 77 coupled to a second set of column drivers 142B. As illustrated, the first portion 148A may include a first three rows 150A of display pixels 77 positioned directly adjacent to the micro-driver 78 while the second portion 148B may include an additional three rows adjacent to the rows 150A of the first portion 148A. Although the illustrated example includes three rows 150 of display pixels 77 in the first portion 148A and an additional three rows in the second portion 148B, first portion 148A and/or the second portion 148B may include any suitable number of rows 150. For example, the first portion 148A and/or the second portion 148B may include 1 or more rows, 2 or more rows, 4 or more rows, 6 or more rows, 8 or more rows, 16 or more rows, 32 or more rows, and so on.

To display a frame of image content, for example, the micro-driver 78 may include a first set of column drivers 142A coupled to and providing the current to the first portion 148A and a second set of column drivers 142B coupled to and providing the current to the second portion 148B. The first set of column drivers 142A may drive rows 150A of (e.g., anodes coupled to) display pixels 77 in the first portion 148A via first emission lines 146A the second set of column drivers 142B may drive the rows 150B of display pixels 77 in the second portion 148B via second emission lines 146B. In particular, a switch 144 of a respective column driver 142 may receive the emission control signal 110 to open or close, thereby blocking or providing current flow from and to the display pixel 77. For example, switches 144 of the first set of column drivers 142A may close to provide current along the first emission lines 146, thereby driving a row 150A of display pixels 77 to emit light. Concurrently, switches 144 of the second set of column drivers 142B may close to provide current along the second emission lines 146, thereby driving a row 150B of display pixels 77 to emit light. In this way, the first set of column drivers 142A may drive a row 150 within the first portion 148A and the second set of column drivers 142B may drive a row 150 within the second portion 148B to emit light at the same time. The timing of emissions may be determined based on a time division multiplexing scheme. For example, the timing may be based on the number of rows 150 within each of the portions 148. In another example, the timing for each portion 148 may be the same. In this way, the micro-driver 78 may drive two rows 150 of display pixels 77 at one time based on the emission clock signal (EM_CLK). As such, the micro-driver 78 may drive multiple rows 150 of display pixels 77 at one time without increasing higher frequency that may produce dynamic power losses.

Since the second portion 148B is positioned farther away from the micro-driver 78 than the first portion 148A, the second emission lines 146B may be longer than the first emission lines 146A. Additionally or alternatively, the second emission lines 146B may cross over the first portion 148A. In particular, the second emission lines 146B may cross over the rows 150A of display pixels 77 in the first portion 148A. In other words, cathodes of the second portion 148B may cross over the anodes of the first portion 148A.

Although the illustrated example includes two sets of column drivers, the micro-driver 78 may include three or more sets of column drivers that drive corresponding portions at the same time, four or more sets of column drivers that drive corresponding portions at the same time, five or more sets of column drivers that drive corresponding portions at the same time, and so on. Take for example, the LPM 92 being divided into four portions 148. The micro-driver 78 may drive a row 150A of display pixels 77 in the first portion 148A, a row 150B of display pixels 77 in the second portion 148B, a row 150C of display pixels 77 in the third portion 148C, and/or a row 150D of display pixels 77 in the fourth portion 148D, at the same time. As such, the micro-driver 78 may drive the LPM 92 without power losses, without increasing frequency, and the like. Additionally or alternatively, the portions 148 may be interleaved rather than being positioned adjacent to each other. For example, a first row 150A of the first portion 148A may be adjacent to a first row 150B of the second portion 148B that may be adjacent to a second row 150A of the first portion 148A. The first set of column drivers 142 may drive the first row 150A and the second row 150A of the first portion 148A and the second set of column drivers 142 may be coupled to and drive the first row 150B of the second portion 148B. As such, the sets of column drivers 142 may collectively operate to drive the display pixels 77 within respective portions at the same time, which may improve operation efficiency. In this way, the size of the LPM 92 may increase even if the frequency is substantially maintained.

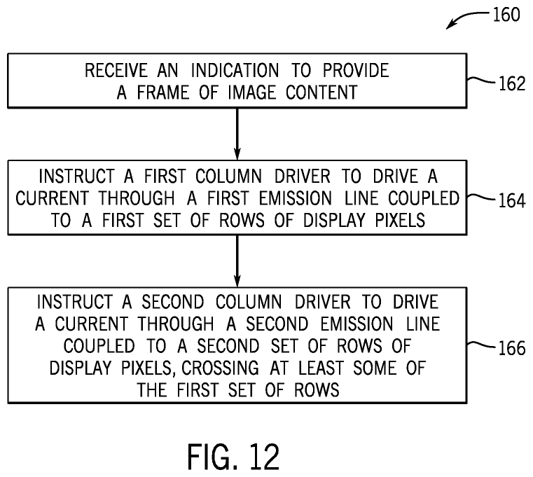

FIG. 12 is a flowchart of an example method 160 or process for operating the LPM 92 using the micro-driver 78. While the process of FIG. 12 is described using process blocks in a specific sequence, it should be understood that the present disclosure contemplates that the described process blocks may be performed in different sequences than the sequence illustrated, and certain described process blocks may be skipped or not performed altogether.

At block 162, processing circuitry (e.g., micro-driver 78) may receive an indication to provide a frame of image content. For example, the micro-driver 78 may receive image data and an emission clock signal (EM_CLK) from the emission timing controller (emission TCON). The emission clock signal (EM_CLK) may control the provision of image data displayed on the electronic display 12. In another example, the micro-driver 78 may receive an emission control signal 110 for driving the display pixels 77 to emit light. The micro-driver 78 may open or close a switch 144 based on the emission control signal 110 to block or allow current flow on the emission line 146.

At block 164, the processing circuitry may instruct a first column driver 142A to drive a current through a first emission line 146A coupled to a first set of rows 150A of display pixels 77. For example, the first set of column driver 142A may be coupled to the first portion 148A of the LPM 92 via a first emission line 146A. A switch of the first set of column drivers 142A may close to allow current to flow along the first emission line 146A and drive the display pixels 77. In certain instances, the first set of rows 150A may be within the first portion 148A positioned directly adjacent to the micro-driver 78. As such, the first emission lines 146 may extend from the micro-driver 78 and through the first portion 148A without cross over additional rows of display pixels 77. In other instances, the first set of rows 150A may be positioned adjacent to another portion 148 and/or interleaved with another portion 148. As such, the first emission lines 146 may cross over additional rows of a different portion 148. Additionally or alternatively, the processing circuitry may instruct the power source 140 to close a switch corresponding to a row 150 of the display pixels 77 to drive the row 150 to emit light.

At block 166, the processing circuitry may instruct a second column driver 142B to drive a current through a second emission line 146B coupled to a second set of rows 150B of display pixels 77, where the second emission line 146B crosses at least some of the first set of rows 150A. For example, a switch 144 of a column driver of the second set of column drivers 142B may close for current to flow along the second emission line 146B to drive the display pixels 77. The second set of rows 150B may be within a second portion 152 of the LPM 92 and may be positioned adjacent to the first portion 148A. As such, the second set of rows 150B may be farther away from the micro-driver 78 in comparison to the first set of rows 150A. To this end, the second emission line 146B may be longer than the first emission line 146A. Additionally or alternatively, the second emission line 146B may cross over the first set of rows 150A, since the second set of rows 150B are positioned adjacent to the first portion 148A. The power source 140 may open a switch corresponding to a row of the display pixels 77 within the second set of rows to drive the respective display pixels 77 to emit light. As discussed herein, the processing circuitry may instruct the first column driver and the second column driver to drive the current through the first emission line and the second emission line, respectively, at the same time. In this way, multiple rows of the electronic display 12 may be driven at one time.

### Pixel Circuitry—Commonly Compensated Column Drivers

Display pixels 77 may be individually compensated, but this may involve multiple components that take up significant layout space within the electronic display 12. Moreover, the column drivers used to drive the display pixels 77 may each have slightly different behavior due to components used in the column driver. In particular, the column drivers may use medium-voltage (MV) transistors with separate n-wells to generate sufficient current to drive the display pixels 77. Each MV transistor may include a slightly different threshold voltage (Vth). As such, each of the column drivers may be individually compensated to account for differences in the threshold voltage (Vth), which may result in the column drivers using significant layout space.

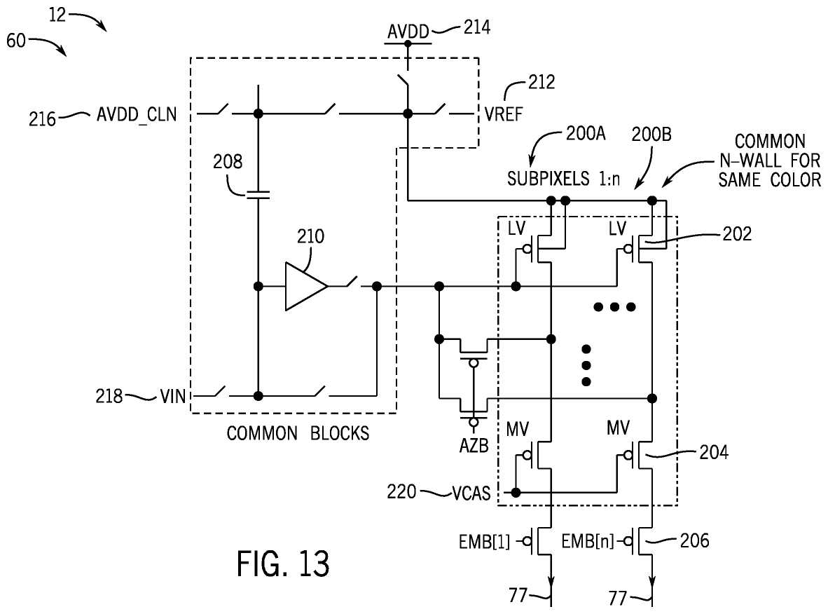

To reduce a size of the column drivers and/or compensate for the different behaviors of the column drivers, a single sampling capacitor 208 may be used to collectively compensate the multiple branches 200 (e.g., column drivers 142 described with respect to FIG. 11). FIG. 13 is a circuit diagram of micro-driver 78 with a common component to compensate branches 200. In particular, the emission lines (e.g., branches of the circuit coupled to the display pixels 77) coupled to the display pixels 77 may be grouped (e.g., integrated) together for collective compensation rather than being positioned in their own n-well, which may reduce an amount of space occupied, for example, within the electronic display 12.

As illustrated, the display pixels 77 may be coupled to respective branches 200 of the circuit. The branch 200 may include a low-voltage (LV) transistor 202 and a MV driving transistor 204 coupled in series. The LV transistor 202 may be smaller in comparison to the MV driving transistors used for individually compensated the display pixels 77. As such, the branches 200 may be grouped closer to each other, which reduces space occupied by the branches 200. Additionally or alternatively, the branches 200 may be grouped in a common n-well 254 which may reduce the space occupied.

The LV transistors 202 may include a thinner gate oxide in comparison to the MV driving transistors discussed above. With a thinner gate oxide, the LV transistors 202 may have improved voltage threshold matching in comparison to only using MV driving transistors.

The LV transistor 202 and the MV driving transistor 204 may be in a cascode formation, which may provide precise current generation without compensating the individual transistors. To this end, a gate of the MV driving transistor 204 may be coupled to a voltage source (VCAS) that provides a voltage to the gate of the MV driving transistor 204. The MV driving transistor 204 and the VCAS voltage source may limit the Vds voltage provided to the LV transistor 202. By adjusting the VCAS voltage source, the Vds voltage provided to the LV transistor 202 does not exceed a voltage threshold (e.g., safe voltage operating range). When closed, the MV driving transistor 204 may provide a current to an additional transistor 206 that drives the display pixel 77. That is, a node of the additional transistor 206 may be coupled to the MV driving transistor 204, a gate of the additional transistor 206 may be coupled to an emission bar source, and a node of the additional transistor 206 may be coupled to the display pixel 77. When the emission bar source is high, the additional transistor 206 drives the current through the display pixel 77. When the emission bar source is low, the additional transistor 206 may not drive the current through the display pixel 77 and the display pixel 77 may not emit light.

Returning to the collective compensation of the display pixels 77, the circuit may include shared (e.g., common) components including a power source, a sampling capacitor 208, and an analog buffer 210. The power source may provide a reference voltage (VREF) 212 coupled to the branches 200, a first analog power signal 214 coupled to the branches 200, a second analog power signal 216 coupled to the sampling capacitor 208, a first digital voltage signal 218 coupled to the analog buffer 210, and a second digital voltage signal 220 coupled to the gates of the MV driving transistor 204. The sampling capacitor 208 may be coupled to the analog buffer 210 and provide an output signal to the analog buffer 210. Additionally or alternatively, the sampling capacitor 208 may compensate for an average voltage threshold (Vth) for all of the transistors 202, 204, 206 and store the average voltage threshold as threshold information in the sampling capacitor 208. The analog buffer 210 may receive a signal from the sampling capacitor 208 indicative of the average threshold of the transistors 202, 204. In this way, the shared components may collectively compensate the display pixels 77.

While the illustrated circuit diagram includes two branches 200 being collectively compensated, it may be understood that the circuit may include any suitable number of branches 200 that may be collectively compensated. For example, the circuit diagram may include three or more branches, for or more branches, five or more branches, and so on. While the illustrated circuit diagram of the display panel 60 includes one sampling capacitor 208 and one analog buffer 210, the display panel 60 may include any suitable number of sampling capacitors 208 and analog buffers 210 coupled to any suitable number of branches 200, such as in different areas of the display panel 60, with respect to different numbers of micro-drivers 78, and the like.

Returning to the circuit, in certain instances, the LV transistors 202 may include an amount of gate leakage, which may result in the LV transistors 202 taking a charge from the sampling capacitor 208 and creating a drop (e.g., voltage drop, current drop). To reduce and/or eliminate gate leakage from the LV transistors 202, the analog buffer 210 may provide a high input impedance and low output impedance. As such, the analog buffer 210 does not draw significant current from the power sources and drives the load to the branches 200. In particular, the analog buffer 210 may output a signal that may be provided to LV transistors 202 to provide a low impedance pathway. As such, the analog buffer 210 may match impedance of the LV transistors 202. Additionally or alternatively, the analog buffer 210 may amplify a signal from the sampling capacitor 208 and/or condition the signal from the sampling capacitor 208 to provide the low output impedance.

Additionally or alternatively, grouping the branches 200 close to each other and/or within the common n-well may result in cross-talk between the branches 200. In particular, the LV transistors 202 may cause the cross-talk. For example, when a first branch 200A turns off and a second branch 200B turns on, some charge from the second branch 200B may transfer to the first branch 200A causing the respective LV transistor 202 on the first branch 200A to turn weakly on. The analog buffer 210 may suppress the cross-talk by providing a low impedance pathway for the charge. As such, the analog buffer 210 may reduce or eliminate the cross-talk by blocking the charge of the second branch 200B from going to the first branch 200A.

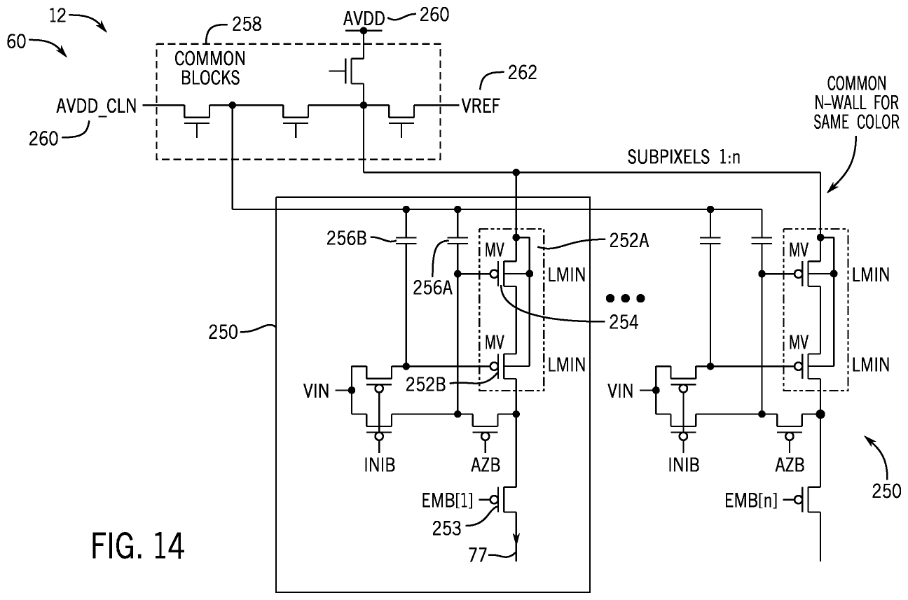

FIG. 14 is a circuit diagram of the micro-driver 78 with common components to compensate the branches 250. In certain instances, a voltage headroom (Vdstat) consumed by the circuit may be reduced by increasing a size of transistors used in branches 250 of the circuit coupled to the display pixels 77, thereby reducing peak power requirements and/or improving operation of the electronic display 12. In other words, increasing a size of the transistors coupled to the display pixels 77 may reduce an amount of power used to drive the display pixels 77 to emit light.

As illustrated, the branches 250 may include MV driving transistors 252 positioned in a common n-well 254. In particular, the branches 250 may include a first MV driving transistor 252A with a node coupled to a common block, a gate coupled to a sampling capacitor, and a node coupled to a second MV driving transistor 252B. The second MV driving transistor 252B may include a gate coupled to a second sampling capacitor, and a node coupled to the display pixel 77 via an additional transistor 253. The MV driving transistors 252 may include a width-to-length (W/L) ratio that is greater than a width-to-length (W/L) ratio of LV transistors. In particular, the MV driving transistors 252 may include an increased width and a minimum length (Lmin) to improve the width-to-length (W/L) ratio. A larger width to length (W/L) ratio may support higher current and lower voltage headroom (Vdstat) in comparison to a smaller width-to-length ratio (W/L).

In certain instances, increasing the width-to-length (W/L) ratio of the MV driving transistors 252 may increase sensitivity to current-resistance (IR) dependent voltage (Vgs, Vds) modulation. For example, a MV driving transistor 252 may include a drain node that may strongly couple to a gate of the circuit and the drain node may steal a charge from the gate which may modulate the current. However, as illustrated, the MV driving transistors 252 may be coupled in series and placed in a common n-well 254 in a cascode formation, thereby reducing the IR dependency of the drain node. The cascode formation may also improve power supply rejection (PSR) by addressing a channel length modulation issue by using a minimum channel length (Lmin). Furthermore, the cascode formation may isolate an IR dependency charge injection of drain to gate capacitance. For example, the first MV driving transistor 252A may attenuate coupling from the drain node to the gate of the circuit. Furthermore, the first MV driving transistor 252A and the second MV driving transistor 252B may increase the output impedance of the current source which may improve the performance of the current source. Additionally or alternatively, placing the first MV driving transistor 252A and the second MV driving transistor 252B in the common (e.g., same) n-well 254 may reduce a size of the branches 250 since n-well 254 to n-well 254 spacing may not be used in the circuit.

The use of the first MV driving transistor 252A and the second MV driving transistor 252B in the cascode formation may reduce a size of the sampling capacitors 256 coupled to a gate of each MV driving transistor 252, respectively. For example, a size of the sampling capacitors 256 may be reduced by half since each MV driving transistor 252 may include a lower voltage headroom (Vdstat). As illustrated, a first sampling capacitor 256A may couple to a gate of a first MV driving transistor 252A and a second sampling capacitor 256B may couple to a gate of a second MV driving transistor 252B. The sampling capacitors 256 may include a threshold voltage (Vth) used to drive the display pixel 77. The drain to gate capacitance of the second MV driving transistor 252B may be first order shielded by the first MV driving transistor 252A from the drain node (e.g., output node). As such, a size of the sampling capacitors 256 may be reduced. As such, the sampling capacitors 256 may individually threshold compensate the display pixels 77.

The branches 250 may be coupled to shared (e.g., common) components 258. In particular, the shared components 258 may include a number of IPC related components (e.g., transistors) shared by the branches 250 that may not be scaled based on the number of display pixels 77, thereby reducing space occupied. The shared components 258 may receive power from a power source that provides an analog power signal 260 and a reference voltage signal (VREF) 262. As illustrated, the shared components 258 may include four transistors coupled to the power signals the branches.

### Dynamic Level Shifter for Micro-LED Displays

As discussed herein, one particularly large component of the display panel 60 and/or the electronic display 12 may be a level shifter, which translates digital signals corresponding to image data into various different voltage levels used to drive the display pixels 77. For example, the level shifter 300 may shift from a one-volt domain to an analog voltage (AVDD) domain. The display pixels 77 may emit light when driven by a signal that swings from an AVDD voltage to a negative voltage (VNEG). The swing from the AVDD voltage to the negative voltage (VNEG) may be between six-volts to eight-volts. As such, to implement the level shifter 300, static latches may be added based on the number of levels shifted. Although eight to ten transistors may be used to implement the static latches. In certain instances, reducing a number of transistors used in the level shifter may reduce an amount of spaced occupied by the level shifter within the display panel 60 and/or the electronic display 12.

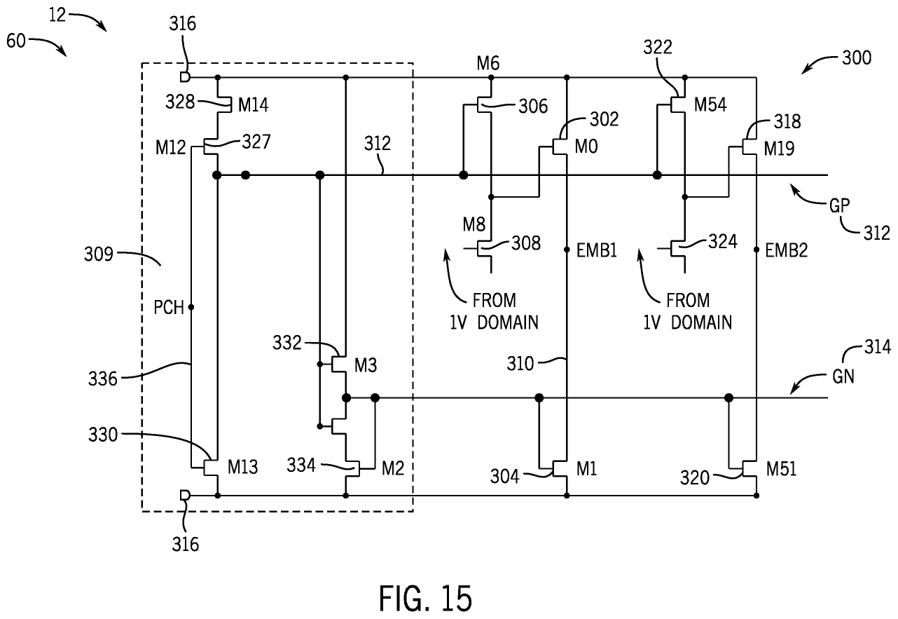

With the foregoing in mind, FIG. 15 is a circuit diagram of a level shifter 300 used in the micro-driver 78. In the illustrated example, the level shifter 300 may use four transistors (M0, M1, M6, M8) 302, 304, 306, 308 to convert the voltage signals. Transistors (M0, M1, M6, M8) 302, 304, 306, 308 maybe coupled to a common block 309, EMB1 line 310, the GP line 312, and the GN line 314. In particular, the M6 transistor 306 may include a node coupled to a power source 316 of the common block 309 that provides a voltage signal in the AVDD domain, a gate coupled to the GP line 312, and a node coupled to the M8 transistor 308. The M8 transistor may include a node coupled M0 transistor 302, a gate coupled to the one-volt signal source (EMB1_1V) and receives a signal in the one-voltage domain, and a node coupled to a ground. The M0 transistor 302 may be coupled to the power source 316 of the common block 309, a gate coupled to the M8 transistor 308, and a node coupled to the M1 transistor 304 via the EMB1 line 310. The M1 transistor 304 may include a node coupled to the M0 transistor 302, a gate coupled to the GN line 314, and a node coupled to the power source 316 providing the negative voltage (VNEG). Additionally or alternatively, the transistors 302, 304, 306, 308 of the level shifter 300 may operate at sub-threshold conduction and/or be pre-charged. After the pre-charge state, the transistors 302, 304, 306, 308 may be in a weak conduction state. As such, fewer transistors may be used to switch voltage levels (e.g., on or off, between voltage domains). The transistors 302, 304, 306, 308 may also be in a high impedance state rather than a low impedance state and consistently conduct an amount of current to maintain the state of the voltage. As such, the level shifter 300 may operate as a dynamic level shifter.

Additionally or alternatively, the level shifter 300 may use four transistors (M19, M51, M42, M51) 318, 320, 322, 324 that may be coupled to the common block 309, the EMB2 line 326, the GP line 312, and the GN line 314. The M54 transistor 322 includes a node coupled to the power source 316, a gate coupled to the GP line 312, and a node coupled to the M42 transistor 324. The M42 transistor 324 may include a node coupled to the M54 transistor 322, a gate coupled to the one-volt signal source (EMB1_1V) and receives a signal in the one-voltage domain, and a node coupled to a ground. The M19 transistor 318 may include a node coupled to the power source 316, a date coupled to the M42 transistor 324, and a node coupled to the M51 transistor 320 via the EMB2 line 326. The M51 transistor 320 includes a node coupled to the M19 transistor 318 via the EMB2 line, a gate coupled to the GN line 314, and a node coupled to the power source 316 that provides the negative voltage (VNEG). Although the illustrated example includes two EMB lines 310 and 326, the display panel 60 and/or the electronic device 10 may include any suitable number of EMB lines coupled to a respective display pixel 77. For example, the display panel 60 and/or the electronic device 10 may include three or more EMB lines, four or more EMB lines, five or more EMB lines, and so on. Each EMB line may provide a signal to drive display pixels 77 of the electronic device 10.

The common block 309 may include transistors (M12, M14, M13. M3, M2) 326, 328, 330, 332, 334. The M12 transistor 327 may include a node coupled to the M14 transistor 328, a gate coupled to the M13 transistor 330 via a pre-charge (PCH) line 336, and a node coupled to the GP line 312. The M14 transistor 328 may include a node coupled to the power source 316 providing the AVDD power signal, a gate coupled to the GP line 312, and a node coupled to the M12 transistor 327. The M13 transistor 330 may include a node coupled to the GP line 312, a gate coupled to the M12 transistor 327 via the PCH line 336, and a node coupled to the power source 316 providing the negative voltage (VNEG). The common block 309 may also include the M3 transistor 332 including a node coupled to the power source 316 providing the AVDD signal, a gate coupled to the GP line 312, and a node coupled to the GN line 314 and the M2 transistor 334 including a node coupled to the GN line 314 via a transistor, a gate coupled to the GN line 314, and a node coupled to the power source 316 providing the negative voltage (VNEG).

The GP line 312 and the GN line 314 may provide control signals to the display pixels 77 when activated by the PCH line 336. The EMB1 line 310 and/or the EMB2 line 326 may be pulled up to the AVDD voltage domain and provide the digital signals in the AVDD domain rather than the one-volt domain. That is, the EMB1 line 310 and/or the EMB2 line 326 may correspond to an emission bar of the display pixels 77. When the EMB1 line 310 and/or the EMB2 line 326 is low, the corresponding display pixels 77 may not be driven to emit light. When the EMB1 line 310 and/or the EMB2 line 326 is high, the display pixels 77 may be driven to emit light. For example, the M6 transistor 306 may turn on to keep the M0 transistor 302 off and the M1 transistor 304 on to pull the EMB1 line 310 down to the negative voltage (VNEG). Once the PCH line 336 goes high, all EMB outputs are pulled low. At the end of the PCH phase and the PCH line 336 goes low, the GP line 312 and GN line 314 are kept at a threshold voltage (Vth) by diode connected the M12 transistors and the M2 transistors working at the sub-threshold conduction level. The sub-threshold conduction of the M1 transistor 304 and the M6 transistor 306 provides a preferred leakage path that keeps the M0 transistor off 302 and the M1 transistor 304 weakly pulls the EMB1 line 310 down to the negative voltage (VNEG). At the end of an EM1 period, the M8 transistor 308 may turn on and pulls the gate of the M0 transistor 302 down which results in the EMB1 line 310 being pulled to the AVDD voltage.

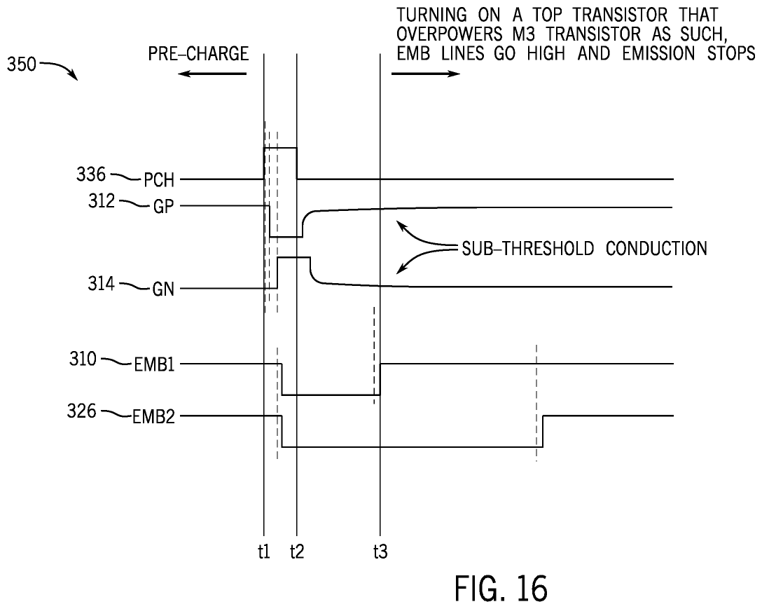

With the foregoing in mind, FIG. 16 is a timing diagram 350 for operating the level shifter 300 to convert a signal from the one-voltage domain to the AVDD domain. In particular, the timing diagram 350 includes the EMB1 line 310, the EMB2 line 326, the GP line 312, the GN line 314, and the PCH line 336 to convert the signals from the one-volt domain to the AVDD domain.

Before time=t1, the reset (RST) line may go high to reset the display pixels 77 coupled to the level shifter 300. After the reset period, the PCH line 336 may go high to pre-charge the transistors of the level shifter 300.

At time=t1, the PCH period may begin and the PCH line 336 may go high. During the PCH period, the transistors (M0, M1, M6, M8) 302, 304, 306, 308 of the level shifter 300 may be pre-charged to a voltage. For example, the M6 transistor 306 may turn on to keep the M0 transistor 302 off and turn on the M1 transistor 304, which may discharge an emission bar (EMB) line to a negative voltage (VNEG). The timing diagram 350 illustrates the EMB1 line 310 and EMB2 line 326 going low at a time after t=t1. When the EMB1 line 310 and EMB2 line 326 are low, the display pixels 77 may be driven to emit light.

When the M6 transistor 306 turns on, the GP line 312 may go low and the GN line 314 may go high. When the GP line 312 goes low, the M3 transistor 332 may turn on and turn off the M6 transistor 306 since the EMB1 line 310 and the EMB2 line 326 are at a low stage (e.g., logic low). Additionally or alternatively, the M8 transistor and the M42 transistor may be off.). When the M3 transistor 332 turns on, the GN line 314 goes high which may cause all bottom transistors (M2, M1) to strongly turn on. The GP line 312 and the GN line 314 may transmit a control signal that may be activated during the PCH period.

When the PCH period goes high, all EMB outputs may be pulled low. The transistors (M8, M42) interfacing the one-volt logic may be turned off. For example, the M8 transistor 308 and the M42 transistor 324 may be turned off.

At time=t2, the PCH period may end and voltage levels may decrease. The GN line 314 may go from a strong on state to a sub-threshold conductance level, while the GP line 312 may go from an off state to the sub-threshold conductance level. In other words, the GP line 312 and the GN line 314 may be kept at a threshold voltage (Vth) level by a diode connecting the M12 transistor 327 and the M2 transistor 334 working at a sub-threshold connection. In other words, the M12 transistor 327 and the M2 transistor 334 may be held weakly on at the end of the PCH period. The sub-threshold conductance of the M1 transistor 304 and the M6 transistor 306 may provide a preferred leakage path that keeps the M0 transistor 302 off. In other words, the M1 transistor 304 and the M6 transistor 306 may leak a little bit of current to provide the preferred leakage path. Additionally or alternatively, the M1 transistor may weakly pull down the EMB1 line 310 to the negative voltage (VNEG).

At time=t3 (e.g., end of the EM1 period), the M8 transistor 308 and/or the M42 transistor 324 interfacing the one-volt logic turns on and pulls the gate of the M0 transistor 302 down to VSS and the EMB1 line 310 may be pulled up to the AVDD voltage. As discussed herein, the gate of the M8 transistor 308 may be connected to the one-volt signal. When the logic sends a signal to the M8 transistor 308, such as zero to one, then the M8 transistor 308 may turn strongly on. Turning on the M8 transistor 308 may override the M6 transistor 306 and cause the M0 transistor 302 to turn on. Additionally or alternatively, the EMB1 line 310 may go up (e.g., pulled up to the AVDD voltage) and emission may start.

Although the timing diagram 350 is described with respect to the EMB1 line 310, the transistors (M19, M51, M42, M51) 318, 320, 322, 324 may be controlled in a similar manner to adjust the EMB2 line 326. The signal from the EMB1 line 310 and the EMB2 line 326 may be used to drive the display pixels 77 to emit light.

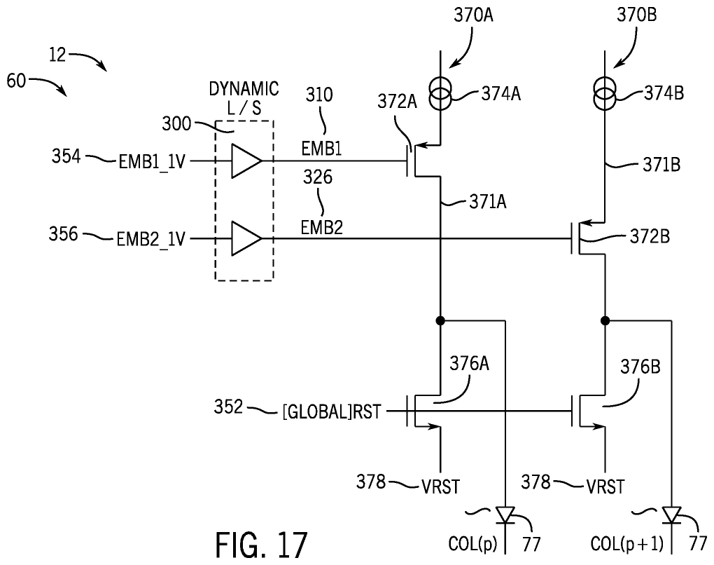

FIG. 17 is a circuit diagram of the level shifter 300 coupled to column drivers 370 (e.g., column drivers 142 described with respect to FIG. 11) of the micro-driver 78. The column drivers 370 may provide a current to drive the display pixels 77 to emit light. The current may be adjusted by the emission signal (EMB1, EMB2) provided by the level shifter 300. As discussed herein, the level shifter 300 may receive an EMB signal in the one-volt domain (EMB1_1V 354, EMB2_1V 356) and convert the signal from the one-volt domain to the AVDD domain. That is, the level shifter 300 may provide the EMB signal in the AVDD domain (EMB1, EMB2). The EMB1 and/or EMB2 signal may turn on or off a transistor coupled to the column drivers 370 to selectively drive the display pixels 77.

Returning to the column drivers 370, a first column driver 370A and a second column driver 370B may be coupled to respective display pixels 77 via a first emission line 371A and a second emission line 371B. For example, the first emission line 371A may include a first transistor 372A with a node coupled to the current source 374A, a gate coupled to the EMB1 signal, and a node coupled to a second transistor 376A. The second transistor 376A may include a gate coupled to the reset signal (RST) 352 and a node coupled to a voltage reset signal (VRST) 378. The reset signal (RST) 352 may adjust the voltage signals of the circuit based on a voltage reset signal (VRST) 376. The second emission line 371B may include a third transistor 372B with a node coupled to a current source 374B, a gate coupled to the EMB2 signal, and a node coupled to a fourth transistor 376B. The fourth transistor 376B may include a gate coupled to the reset signal (RST) 352 and a node coupled to a voltage reset signal (VRST) 378.

When the EMB1 signal is low (e.g., active low), the first transistor 372A may turn on which may cause the first the first column driver 370A may drive the display pixel 77 to emit light via the first emission line 371A. When the EMB1 signal is high, the first emission line 371A may not provide a current and the display pixel 77 may not emit light. Similarly, when the EMB2 signal is low, the third transistor 372B may turn on and cause the second emission line 371B may provide a current to display pixel 77. The EMB1 signal and/or the EMB2 signal may be an AVDD voltage signal or a VNEG voltage signal converted by the level shifter 300. As such, the AVDD voltage signal or a VNEG voltage signal may be provided to the display pixels 77.

### High-Resolution Emission (EM) Pulse Generator

In certain instances, increasing a dynamic range of a frame of image content displayed by the electronic display 12 may be controlled by extending an emission clock signal (EM_CLK) by a fractional amount. For example, a digital code of four may correspond to four emission clock pulses, in which a second pulse of the emission clock may be slightly longer than the first pulse, the third slightly longer than the second, and so on. By extending the emission clock pulse by a fractional amount, the values of the emission clock signal (EM_CLK) may be increased, which may increase the resolution. For example, the digital code may include values of 1, 2, 3, and 4 corresponding to respective numbers of emission clock pulses. With the extended emission clock pulses, the digital code may include values of 1.2, 1.4, 1.6, 1.8, 2.2, 2.4, 2.6, and so on. In this way, the extended emission clock pulses may increase resolution of the emission clock signal (EM_CLK).

As discussed herein, the emission clock signal (EM_CLK) may be generated by the emission timing controller (TCON). For example, the emission clock signal (EM_CLK) my include a pulse of 10 nanoseconds, as such, the display panel 60 resolution may be 10-nanoseconds and correspond to a range of 256 gray levels. Additionally or alternatively, a minimum emission clock pulse may correspond to the panel resolution. In the illustrated example, the minimum pulse width may be 10-nanoseconds.

In certain instances, the emission clock pulse may be finer than the panel resolution to provide a higher dynamic range. The range of gray levels may be increased using finer emission clock pulses. For example, an 8-bit gray level may be increase to 10-bit gray level by extending the emission clock pulses. Additionally or alternatively, a finer control of the emission clock pulses may increase a number of bits supported by the electronic display 12. The emission clock pulse may be extended, for example, by adding a programmable delay the emission clock signal (EM_CLK). As such, the emission clock pulse may be extended by a fractional amount.

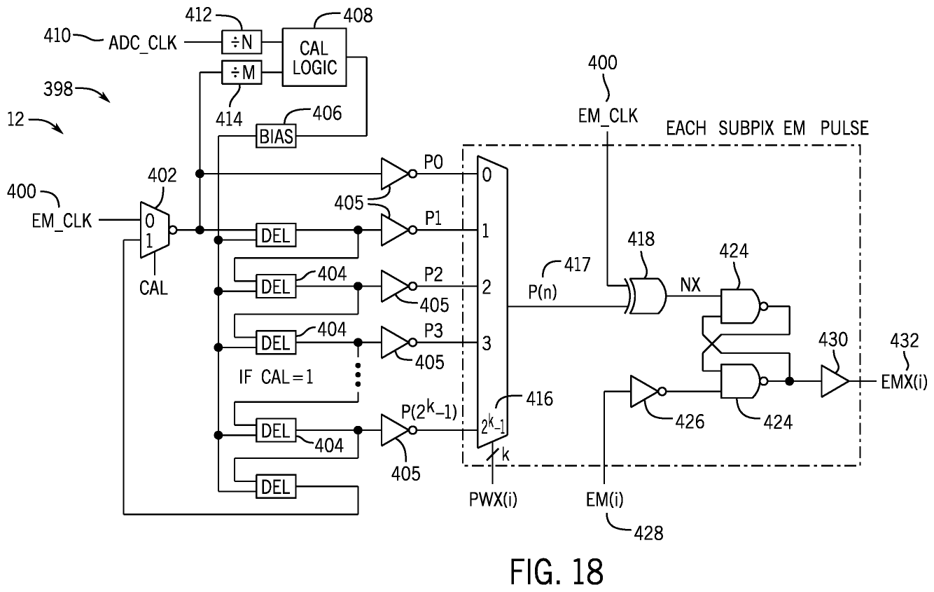

With the foregoing in mind, FIG. 18 is a circuit diagram an emission (EM) pulse generator 398 adding a programmable delay to the emission clock signal (EM_CLK) 400 to generate an extended emission clock signal (EM_CLK). The micro-driver 78 may receive the emission clock signal (EM_CLK) 400 from the emission TCON within the support circuitry 62. The emission clock signal (EM_CLK) 400 may be received by a first multiplexer 402. A calibration mode may be activated if CAL=1. For example, CAL=1 may be a dedicated calibration interval when the electronic device 10 does not display image content, such as a frame pause, and the emission clock signal (EM_CLK) 400 may not be toggling. If CAL=0, a programmable extension may be added to the emission clock signal (EM_CLK) 400. To this end, delay cells 404 may form a ring oscillator and provide a pulse extension that may be added to the emission clock signal (EM_CLK). For example, the output of each delay cell 404 may be received by a subsequent delay cell 404 via a buffer 405 (e.g., inverter) to create a closed loop. The ring oscillator formed by the delay cells 404 may include a period corresponding to the period of the delay cells 404 and a timing delay provided by a bias block 406. As illustrated, the circuit includes five delay cells 404, however any suitable number of delay cells 404 may be included in the circuit. For example, the number of delay cells 404 may be an odd number in order for the delay cells 404 to form the ring oscillator. The delay cells 404 may not use static power, which may improve efficiency of the circuit.

Returning to the delay cells 404, the delay cells 404 may be controlled by a bias block 406 that may be tuned by calibration logic 408 based on an analog-to-digital clock signal (ADC_CLK) 410. The bias block 406 may be calibrated during window, such as a calibration window, to provide a delay to each of the delay cells 404. The timing delay provided by the bias block 406 may be proportional to a resistor and/or a current in the bias block 406 and a first order supply independent. In another example, the timing delay may be determined based on a period of the analog-to-digital clock signal (ADC_CLK) 410, an N value (e.g., provided by block 412), an M value (e.g., provided by block 414), and a period of the delay cells 404. By way of illustrative example, the panel resolution may be 10-nanoseconds. Accordingly, the delay cells 404 may be calibrated to sub-10-nanosecond resolutions based on the bias block 406. For example, the delay cell 404 may include a delay equivalent to an eighth of the panel resolution or 1.25 nanoseconds.

The delay cells 404 may each output a programmable extension (P) that may be received by a second multiplexer 416. The second multiplexer 416 may control an emission pulse extension signal (PWX(i)) that may be added to the emission pulse of the emission clock signal (EM_CLK). For example, the second multiplexer 416 may receive multiple programmable extensions (P) from each of the delay cells 404 and combine the multiple programmable extensions (P) into one output signal (P(n)) 417 provided to a XOR gate 418. The XOR gate 418 may also receive the emission clock signal (EM_CLK) 400 from, for example, the emission TCON. Based on the output signal from the second multiplexer 416 and the emission clock signal (EM_CLK) 400, the XOR gate 418 may output an extension signal (NX) 420. That is, the extension signal (NX) 420 may be a logic high if either the programmable extension (P) or the emission clock pulse (EM(i)) 428 is a logic high, but not both.

The extension signal (NX) 420 may be added to an emission clock pulse (EM(i)) 428 by two additional NAND gates 424. The emission clock pulse (EM(i)) 428 may be provided to a NOT gate 426 that inverts the pulse signal prior to transmitting the pulse signal to the NAND gate 424. The emission clock pulse (EM(i)) 428 may be added with the extension signal (NX) 420 to generate an extended emission clock pulse (EMX(i)) 432 at a buffer 430. The extended emission clock pulse (EMX(i)) 432 may be longer than the emission clock pulse (EM(i)) 428 by a fractional amount, such as based on the programmable delay provided by the delay cells 404. As such, panel resolution and/or a dynamic range of the display panel 60 may be improved.

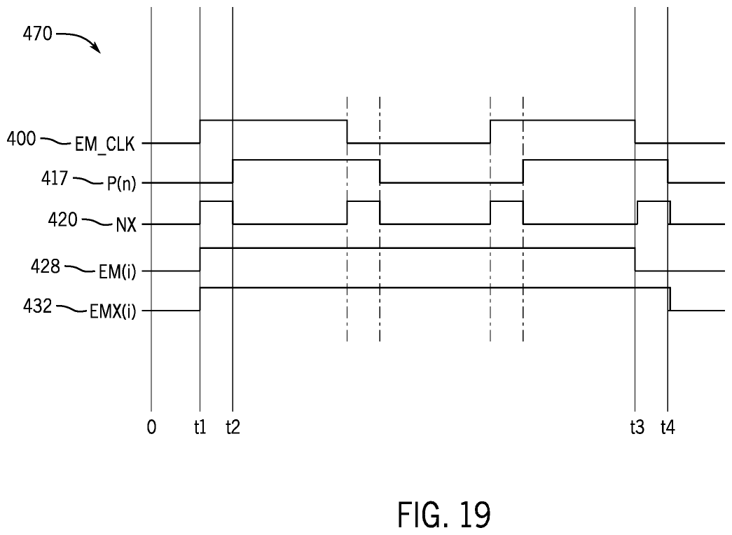

FIG. 19 is a timing diagram 470 for operating the EM pulse generator. The emission clock pulse may be extended by a programmable amount using calibrated delay cell outputs. By extending the emission clock pulse, the range of a frame of image content displayed on the electronic display 12 may be increased.

At time t=t0, the emission clock signal (EM_CLK) 400 may be at a logic low and the programmable extension signal (P(n)) 417 outputted by the delay cells 404 may be at a logic low. That is, CAL may not be equal to 1 and the delay cells 404 may not form the ring oscillator.

At time=t1, the emission clock signal (EM_CLK) 400 may be at a rising edge and go to logic high while the programmable extension signal (P(n)) 417 may remain at the logic low. For example, CAL=0 and the delay cells 404 may form the ring oscillator. The emission clock signal (EM_CLK) 400 and the programmable extension signal (P(n)) 417 may be received at the XOR gate 418. The XOR gate 418 may output the extension signal (NX) 420, which may be a logic high. Additionally or alternatively, the emission clock pulse (EM(i)) 428 may start at time t=t1 and be at a logic high.

At time t=t2, the emission clock signal (EM_CLK) 400 may remain at the logic high and the programmable extension signal (P(n)) 417 may be at a rising edge and go to a logic high. As such, the XOR gate 418 may output the extension signal (NX) 420 at the logic low.

At time t=t3, the emission clock signal (EM_CLK) 400 may be at a falling edge and the programmable extension signal (P(n)) 417 may be at the logic high. As such, the extension signal (NX) 420 may be at a rising edge, which may be added to the emission clock pulse (EM(i)) 428 to generate the extended emission clock pulse (EMX(i)) 432. As illustrated, the emission clock pulse (EM(i)) 428 may be at a falling edge and the extended emission clock pulse (EMX(i)) 432 may be at a logic high.

At time t=t4, the emission clock signal (EM_CLK) 400 may be at a logic low, the programmable extension signal (P(n)) 417 may be at a falling edge, the emission clock pulse (EM(i)) 428 may be at a logic low, and the extended emission clock pulse (EMX(i)) 432 may be at a falling edge.

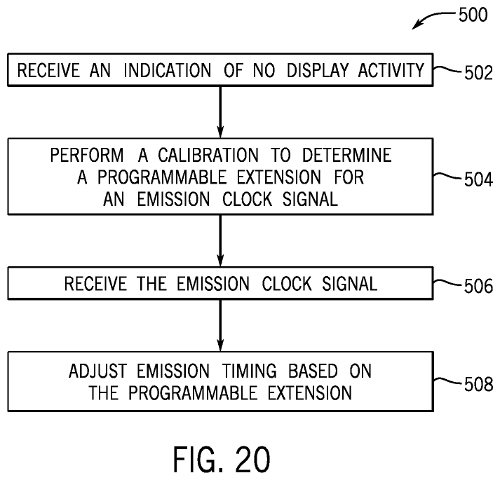

FIG. 20 is a flowchart of an example method 500 or process for operating the EM pulse generator. While the process of FIG. 20 is described using process blocks in a specific sequence, it should be understood that the present disclosure contemplates that the described process blocks may be performed in different sequences than the sequence illustrated, and certain described process blocks may be skipped or not performed altogether.

At block 502, processing circuitry (e.g., micro-driver 78) may receive an indication of no display activity. For example, the processing circuitry may receive an indication of a frame pause. In another example, the processing circuitry may determine that CAL=1, which may be a dedicated calibration interval when the electronic device 10 is not displaying image content. Additionally or alternatively, the processing circuitry may receive an indication that the emission clock signal (EM_CLK) may not be toggling.

At block 504, the processing circuitry may perform a calibration to determine a programmable extension for an emission clock signal. For example, the processing circuitry may determine the programmable extension signal (P(n)) 417 based on a bias from a bias block 406. The bias block 406 may be tuned by calibration logic based on the analog-to-digital clock signal (ADC_CLK) 410. The calibration logic may provide a timing delay that may be programmed into delay cells 404. In the calibration mode, the delay cells 404 may form a ring oscillator with a period equal to 2^{k}t_{del}, where each delay cells 404 include a period of 2 k. The period 2^{k}t_{del} may be provided as a programmable extension signal (P(n)) 417 to adjust the emission clock signal (EM_CLK) 400. The period may be received by the second multiplexer 416 to control the emission pulse extension. As such, the delay cells 404 may be calibrated based on the delay provided by the bias block 406 when CAL=1.

At block 506, the processing circuitry may receive the emission clock signal (EM_CLK) 400. As discussed herein, the support circuitry 62 may include the emission timing controller (TCON) that provides an emission clock signal (EM_CLK) 400. The emission clock signal (EM_CLK) 400 may correspond to a resolution of the display panel 60 and/or the electronic device 10.

At block 508, the processing circuitry may adjust the emission timing based on the programmable extension (P(n)) 417. For example, the processing circuitry may add the programmable extension (P(n)) 417 to the emission clock signal (EM_CLK) 400 when CAL=0. The XOR gate 418 may receive the emission clock signal (EM_CLK) 400 and the programmable extension signal (P(n)) 417 to generate the extension signal (NX) 420. The extension signal (NX) 420 may be combined with the emission clock pulse (EM(i)) to generate an extended emission clock pulse (EMX(i)) 432 that may be programmed into the display pixels 77. The extension signal (NX) 420 may be added to either the rising edge or the falling edge of the emission clock pulse (EM(i)) 428. Additionally or alternatively, the extension signal (NX) 420 may be added to either the rising edge and/or the falling edge of the emission clock signal (EM_CLK) 400 to extend the signal by a programmable amount. As such, the emission pulse of the emission clock signal (EM_CLK) 400 may be extended by a programmable amount based on the delay cells 404, thereby improving a resolution of the emission clock signal (EM_CLK).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An electronic device, comprising:
a local passive matrix comprising a first set of rows of display pixels and a second set of rows of display pixels; and
a micro-driver configured to drive the local passive matrix, the micro-driver comprising:
a negative voltage source configured to be selectively coupled simultaneously to one row of the first set of rows and one row of the second set of rows;
a first column driver coupled to the first set of rows via a first emission line and configured to drive a current through the one row of the first set of rows that is selectively coupled to the negative voltage source; and
a second column driver coupled to the second set of rows via a second emission line and configured to drive a current through the one row of the second set of rows that is selectively coupled to the negative voltage source, wherein second emission line crosses at least the one row of the first set of rows.

2. The electronic device of claim 1, wherein the first emission line is shorter than the second emission line.

3. The electronic device of claim 1, wherein the negative voltage source is configured to be selectively coupled via a plurality of switches coupled to each row of the first set of rows and each row of the second set of rows.

4. The electronic device of claim 3, wherein closing a switch of the plurality of switches causes a respective row of the first set of rows and a respective row of the second set of rows to emit light when driven.

5. The electronic device of claim 1, wherein the first set of rows is positioned directly adjacent to the micro-driver.

6. The electronic device of claim 5, wherein the second set of rows is positioned adjacent to the first set of rows.

7. The electronic device of claim 1, wherein the local passive matrix comprises a third set of rows of display pixels and a fourth set of rows of display pixels, wherein the negative voltage source is configured to be selectively coupled simultaneously to one row of the third set of rows and one row of the fourth set of rows, and wherein the micro-driver comprises:
a third column driver coupled to the third set of rows via a third emission line and configured to drive a current through the one row of the third set of rows that is selectively coupled to the negative voltage source; and
a fourth column driver coupled to the fourth set of rows via a fourth emission line and configured to drive a current through the one row of the fourth set of rows that is selectively coupled to the negative voltage source, wherein the fourth emission line crosses over the third set of rows.

8. The electronic device of claim 7, wherein the third set of rows is positioned directly adjacent to the micro-driver, and wherein the fourth set of rows is positioned adjacent to the third set of rows.

9. The electronic device of claim 7, wherein the first column driver, the second column driver, the third column driver, and the fourth column driver are configured to operate at the same time.

10. An electronic device, comprising:
a micro-driver comprising a first column driver and a second column driver, wherein the first column driver and the second column driver are configured to operate at the same time;
a first display pixel in a first row coupled to the first column driver via a first emission line; and
a second display pixel in a second row coupled to the second column driver via a second emission line.

11. The electronic device of claim 10, wherein the second emission line crosses the first row.

12. The electronic device of claim 10, wherein the first row is directly adjacent to the micro-driver and the second row is adjacent to the first row.

13. The electronic device of claim 10, wherein the first column driver and the second column driver are configured to operate at the same time comprises:
the first column driver driving a current through the first row; and
the second column driver driving a current through the second row at the same time as the first column driver.

14. The electronic device of claim 10, wherein the micro-driver comprises a negative voltage source coupled to the first row and the second row.

15. The electronic device of claim 14, wherein the negative voltage source comprises a first switch coupled to the first row and a second switch coupled to the second row, and wherein closing the first switch the first row to emit light.

16. An electronic device, comprising:
a local passive matrix comprising a first portion and a second portion, wherein the first portion comprises a first set of rows of display pixels and the second portion comprises a second set of rows; and
a micro-driver coupled to the first portion via a first emission line and the second portion via a second emission line, the micro-driver configured to drive a row of the first portion and a row of the second portion at the same time.

17. The electronic device of claim 16, wherein the first portion is directly adjacent to the micro-driver and the second portion is adjacent to the first portion.

18. The electronic device of claim 16, wherein the micro-driver comprises:
a first column driver coupled to the first portion via the first emission line; and
a second column driver coupled to the second portion via the second emission line that crosses over the first portion.

19. The electronic device of claim 16, wherein the micro-driver comprises:
a first column driver coupled to the first portion via the first emission line; and
a second column driver coupled to the second portion via the second emission line that is longer than the first emission line.

20. The electronic device of claim 16, wherein the local passive matrix comprises a third portion and a fourth portion, and wherein the micro-driver is configured to drive a row of the third portion and a row of the fourth portion at the same time as the row of the first portion and the row of the second portion.
